(19) United States
(12) Patent Application Publication
(10) Pub. No.: US 2026/0370523 A1
(43) Pub. Date: Nov. 19, 2026

(54) SCRAMBLING FOR NON-LINEAR CHANNEL ENCODING AND POWER SHAPING

(71) Applicant: QUALCOMM Incorporated, San Diego, CA (US)

(72) Inventors: Akash Sandeep DOSHI, San Diego, CA (US); June NAMGOONG, San Diego, CA (US); Wei YANG, San Diego, CA (US)

(21) Appl. No.: 19/672,441

(22) Filed: May 8, 2026

Related U.S. Application Data
(60) Provisional application No. 63/806,236, filed on May 15, 2025.

(51) Int. Cl. H04L 25/03

(52) U.S. Cl. CPC H04L 25/03866; H04L 25/03171; H04L 25/03178

(57) ABSTRACT

This disclosure provides methods, components, devices, and systems for scrambling for non-linear channel encoding and power shaping. For example, techniques described herein support non-linear channel encoding with message-level scrambling (e.g., supporting a same error probability across message sequences) in the case of per-codeword power shaping schemes (e.g., supporting more efficient allocation of power across message sequences). A user equipment (UE) may perform message-level scrambling while ensuring that a message sequence is scrambled to a message sequence with the same prior probability. For instance, the UE may scramble one message sequence to another message sequence having the same prior probability. However, the UE may scramble a first message sequence to a second message sequence if the first and second message sequences have the same prior probability.

### CROSS REFERENCE

This patent application claims the benefit of U.S. Provisional Application No. 63/806,236 by Doshi et al., entitled “SCRAMBLING FOR NON-LINEAR CHANNEL ENCODING AND POWER SHAPING,” filed May 15, 2025, assigned to the assignee hereof, and expressly incorporated herein.

### TECHNICAL FIELD

This disclosure relates generally to wireless communication, and more specifically to systems, devices, methods, and techniques associated with scrambling for non-linear channel encoding and power shaping.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a UE is described. The method may include generating a message sequence corresponding to (e.g., of) a set of multiple message sequences, each message sequence corresponding to a respective prior probability value, performing message-level scrambling of the message sequence, the message-level scrambling including scrambling a first message sequence of the set of multiple message sequences to a second message sequence of the set of multiple message sequences, where the second message sequence has a same prior probability value as the first message sequence, encoding the scrambled message sequence based on a non-linear channel encoder configured to encode and modulate the scrambled message sequence to generate a codeword, and transmitting a signal including the codeword generated from the non-linear channel encoder.

A UE for wireless communications is described. The UE may include a processing system that includes processor circuitry and memory circuitry that stores code. The processing system may be configured to cause the UE to generate a message sequence corresponding to a set of multiple message sequences, each message sequence corresponding to a respective prior probability value, perform message-level scrambling of the message sequence, the message-level scrambling including scrambling a first message sequence of the set of multiple message sequences to a second message sequence of the set of multiple message sequences, where the second message sequence has a same prior probability value as the first message sequence, encode the scrambled message sequence based on a non-linear channel encoder configured to encode and modulate the scrambled message sequence to generate a codeword, and transmit a signal including the codeword generated from the non-linear channel encoder.

Another UE for wireless communications is described. The UE may include means for generating a message sequence corresponding to a set of multiple message sequences, each message sequence corresponding to a respective prior probability value, means for performing message-level scrambling of the message sequence, the message-level scrambling including scrambling a first message sequence of the set of multiple message sequences to a second message sequence of the set of multiple message sequences, where the second message sequence has a same prior probability value as the first message sequence, means for encoding the scrambled message sequence based on a non-linear channel encoder configured to encode and modulate the scrambled message sequence to generate a codeword, and means for transmitting a signal including the codeword generated from the non-linear channel encoder.

A non-transitory computer-readable medium storing code for wireless communications is described. The code may include instructions executable by one or more processors to generate a message sequence corresponding to a set of multiple message sequences, each message sequence corresponding to a respective prior probability value, perform message-level scrambling of the message sequence, the message-level scrambling including scrambling a first message sequence of the set of multiple message sequences to a second message sequence of the set of multiple message sequences, where the second message sequence has a same prior probability value as the first message sequence, encode the scrambled message sequence based on a non-linear channel encoder configured to encode and modulate the scrambled message sequence to generate a codeword, and transmit a signal including the codeword generated from the non-linear channel encoder.

Some examples of the method, user equipment (UEs), and non-transitory computer-readable medium described herein may further include operations, features, means, or instructions for permuting information bits of the message sequence in accordance with a pseudorandom permutation function, based on each bit of the message sequence being sampled independently of all other bits of the message sequence and each bit of the message sequence being sampled from a same distribution.

In some examples of the method, user equipment (UEs), and non-transitory computer-readable medium described herein, each respective prior probability value for each message sequence of the set of multiple message sequences may be the same based on the pseudorandom permutation function, and scrambling the first message sequence of the set of multiple message sequences to the second message sequence may be based on each respective prior probability value for each message sequence of the set of multiple message sequences being the same.

Some examples of the method, user equipment (UEs), and non-transitory computer-readable medium described herein may further include operations, features, means, or instructions for dividing the set of multiple message sequences into one or more sets of message sequences, each message sequence of each set of message sequences corresponding to a same prior probability value, selecting the first message sequence from the set of multiple message sequences for scrambling, the first message sequence corresponding to a first set of message sequences of the one or more sets of message sequences, and selecting the second message sequence from the set of multiple message sequences based on the second message sequence corresponding to the first set of message sequences, where the second message sequence corresponds to the same prior probability value as the first message sequence based on the first message sequence and the second message sequence corresponding to the first set of message sequences in accordance with the dividing of the set of multiple message sequences into the one or more sets of message sequences.

Some examples of the method, user equipment (UEs), and non-transitory computer-readable medium described herein may further include operations, features, means, or instructions for refraining from selecting a message sequence from a second set of message sequences of the one or more sets of message sequences based on the dividing of the set of multiple message sequences into the one or more sets of message sequences, the second set of message sequences corresponding to an additional prior probability value that may be different than the prior probability value of the first set of message sequences, where scrambling the first message sequence to the second message sequence may be based on the refraining.

In some examples of the method, user equipment (UEs), and non-transitory computer-readable medium described herein, scrambling the first message sequence by another message sequence from a second set of message sequences of the one or more sets of message sequences may be restricted in accordance with the dividing.

Some examples of the method, user equipment (UEs), and non-transitory computer-readable medium described herein may further include operations, features, means, or instructions for performing the message-level scrambling based on a pseudorandom phase that may be based on a seed.

Some examples of the method, user equipment (UEs), and non-transitory computer-readable medium described herein may further include operations, features, means, or instructions for receiving control signaling indicating the seed.

In some examples of the method, user equipment (UEs), and non-transitory computer-readable medium described herein, the seed may be based on a slot index, a frame index, a subframe index, a symbol index, a physical resource block index, a transmission index, a cell identifier, a device identifier, a radio network temporary identifier, or any combination thereof.

### BRIEF DESCRIPTION OF THE DRAWINGS

FIG. 1 shows an example of a wireless communication system.

FIG. 2 shows an example of a signaling diagram that supports scrambling for non-linear channel encoding and power shaping.

FIG. 3 shows an example of a process flow that supports scrambling for non-linear channel encoding and power shaping.

FIG. 4 shows a block diagram of a processing system that supports scrambling for non-linear channel encoding and power shaping.

FIG. 5 shows a diagram of a system including a device that supports scrambling for non-linear channel encoding and power shaping.

FIGS. 6 through 8 show flowcharts illustrating methods that support scrambling for non-linear channel encoding and power shaping.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IOT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, a user equipment (UE) may communicate with a network entity. The UE may transmit uplink signaling (e.g., via a physical uplink shared channel (PUSCH) or a physical uplink control channel (PUCCH)). The UE may support non-linear (e.g., artificial intelligence (AI)-based or machine learning (ML)-based) channel coding, which may result in per-codeword error probabilities of channel codes that are different from codeword to codeword. The UE may therefore support message-level scrambling to ensure each message sequence has a same error probability, which may include scrambling information bits prior to encoding. However, the UE may also support per-codeword power shaping (PS) to allocate low power to message sequences with high prior probabilities, which may reduce block error (BLER) for uplink signaling. Such allocation may be impacted by the message-level scrambling. For example, if a low probability message sequence is scrambled to a high probability message sequence, then the characteristics of the PS scheme may be violated (e.g., the UE may allocate low power to a message sequence with a high prior probability, but the sequence may be scrambled, resulting in a low prior probability, in which case the low power may be allocated to a message sequence with low prior probability, in direct opposition to the advantages of the PS scheme).

Aspects of the subject matter described in this disclosure relate to non-linear channel encoding and message-level scrambling with power shaping procedures. For example, techniques described herein support non-linear channel encoding with message-level scrambling (e.g., supporting a same error probability across message sequences) in the case of per-codeword power shaping schemes (e.g., supporting more efficient allocation of power across message sequences). The UE may perform message-level scrambling while ensuring that a message sequence is scrambled to a message sequence with the same prior probability. For instance, the UE may scramble one message sequence to another message sequence having the same prior probability (e.g., may multiply a first message sequence by a value or a vector, or in accordance with a function, or may ensure that a scrambled message sequence has the same prior probability value as the unscrambled message sequence, etc.). However, the UE may scramble a first message sequence to a second message sequence if the first and second message sequences have the same prior probability.

Particular aspects of the subject matter described in this disclosure can be implemented to realize one or more of the following potential advantages. In some examples, described techniques may reduce per-codeword BLER spread, without increasing the average BLER. For example, the PS procedure may reduce the BLER, and per-message scrambling using message sequences having the same prior probability may also support efficient power allocation (e.g., message-level scrambling with different prior probabilities may eliminate the benefits of PS schemes, and may therefore increase BLER, which can be avoided by implementing the techniques described herein).

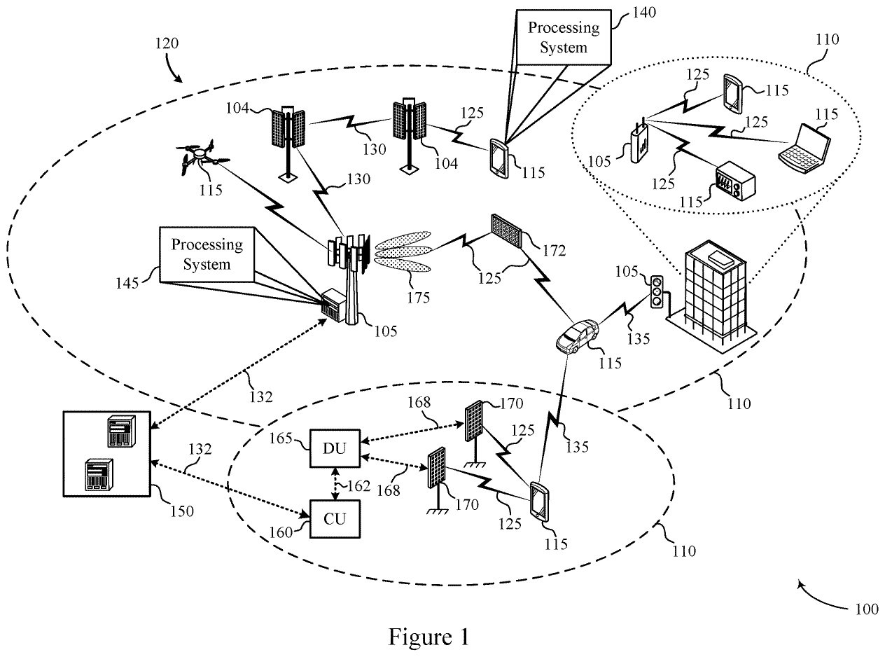

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more relays 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHZ), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects of the described techniques for scrambling for non-linear channel encoding and power shaping. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may reduce per-codeword BLER spread, without increasing the average BLER. For example, the PS procedure described herein may reduce the BLER, and per-message scrambling described herein using message sequences having the same prior probability may also support efficient power allocation.

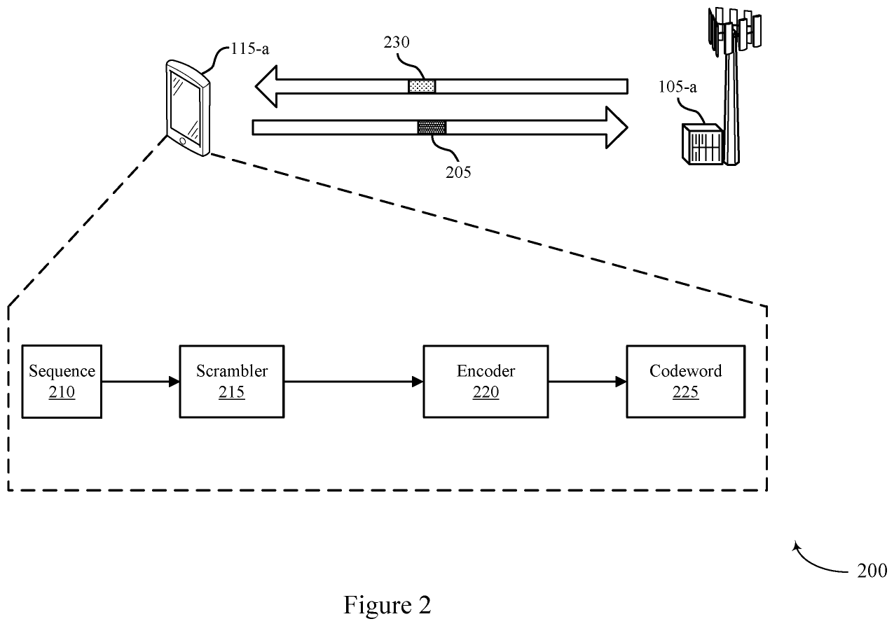

FIG. 2 shows an example of a signaling diagram 200 that supports scrambling for non-linear channel encoding and power shaping. The signaling diagram 200 may implement, or be implemented by, aspects of the wireless communications system 100. For example, the signaling diagram 200 may include a transmitting device (e.g., a UE 115-a and a network entity) and a receiving device (e.g., a network entity 105-a), which may be examples of corresponding devices described with reference to FIG. 1.

The UE 115-a may support channel coding, such as non-linear channel coding. For instance, the UE 115-a may perform channel coding based on an AI or ML model. Channel codes that are generated or augmented using an AI or ML model may be non-linear (e.g., unless explicit linearity is imposed on the AI or ML model). As a result of such non-linearity, per-codeword error probabilities of channel codes may be different from codeword to codeword.

For example, the scrambler 215 may scramble a message sequence (e.g., the sequence 210) based on a scrambling configuration. The sequence 210 may correspond to one or more messages (e.g., the UE 115-a may perform message-level scrambling on multiple messages or message sequences). The sequence 210 may be a sequence of values (e.g., bits, information, data, or signal information, among other examples). A message sequence may represent (e.g., may represent a portion of) voice, audio, video, text, or other data. In some examples, the message sequence may be expressed as u∈{1,−1}^{k}. Scrambling the message sequence (e.g., scrambling the sequence 210 by the scrambler 215) may generate a scrambled message sequence (e.g., u′).

A scrambling configuration may be information indicating one or more aspects for scrambling. For example, a scrambling configuration may indicate a change of a scrambling sequence (for changing a scrambling sequence between transmissions, for instance), a seed for generating pseudorandom information, a pseudorandom sequence (e.g., a pseudorandom binary sequence), a pseudorandom matrix (e.g., P), a pseudorandom function, a pseudorandom permutation rule, or any combination thereof. In some examples, the network entity 105-a may transmit the scrambling configuration to the UE 115-a. For instance, the network entity 105-a may transmit a control message 230 (e.g., MAC control element (CE) or an RRC message, among other examples) that may include a scrambling configuration (e.g., an indication of the seed).

In some approaches, scrambling the message sequence may be based on a seed for generating pseudorandom information. For example, the scrambler 215 may utilize a seed to generate a pseudorandom scrambling sequence (e.g., pseudorandom binary scrambling sequence), a matrix, a pseudorandom permutation rule, or a pseudorandom permutation function. The seed may be based on a time slot, a subslot, a frame, a subframe, a symbol index (e.g., a first OFDM symbol index, a last OFDM symbol index, or another symbol index), a subcarrier index (e.g., a first subcarrier index, a last subcarrier index, or another subcarrier index), a resource block or resource block index (e.g., a first or last physical resource block (PRB), another PRB, a first PRB index, a last PRB index, or another PRB index), an identifier of a wireless device (e.g., an identifier of the UE 115-a, an identifier of the network entity 105-a, or a UE identifier), an identifier of a cell (e.g., an identifier of a cell or a network entity), a transmission index (e.g., an index of a transmission of a signal in a case that transmissions are indexed), other information, or any combination thereof. The time slot, subslot, frame, subframe, symbol index, subcarrier index, resource block or resource block index, identifier of a wireless device, identifier of a cell, transmission index, or other information may be associated with the transmission of a signal (e.g., signaling 205).

The UE 115-a (e.g., the scrambler 215) may generate the pseudorandom information based on the seed. The pseudorandom information may include a pseudorandom binary sequence, a pseudorandom matrix, a pseudorandom permutation rule, or any combination thereof.

In some examples, the scrambler 215 may scramble a message sequence (e.g., u) using a k-length pseudorandom sequence (e.g., a pseudorandom binary sequence or a Gold sequence, among other examples). In some approaches, a descrambler (e.g., at the network entity 105-a) may utilize the k-length pseudorandom sequence to perform corresponding descrambling. For instance, the scrambling configuration may indicate the seed or the pseudorandom sequence, which the descrambler may utilize for descrambling.

In some examples, the scrambler 215 may scramble a message sequence by multiplying the message sequence (e.g., u) by a k×k invertible pseudorandom matrix (e.g., P). An invertible transformation (e.g., multiplying the message sequence by the k×k pseudorandom matrix, which may be based on or may otherwise be associated with another message sequence) may be undone at the receiving device when the receiver has the pseudorandom matrix (e.g., P). In some examples, the scrambler 215 may permute or interleave the information bits in the message sequence (e.g., u) with a pseudorandom permutation function or with a pseudorandom permutation rule, or with another message sequence.

In some aspects, the scrambling performed on the message sequence may be referred to as message-level scrambling. For instance, the message sequence may be scrambled before encoding. Scrambling the message sequence may be performed to reduce a per-message block error rate (BLER) spread of a set of message sequences that includes the message sequence. For example, the message sequence may be scrambled to ensure that each message sequence (e.g., u) has approximately the same error probability. In the case of message-level scrambling, the UE 115-a may scramble one message sequence of the message sequences to another message sequence.

The UE 115-a may encode the scrambled message sequence (e.g., u′) using the encoder 220 (e.g., a non-linear channel encoder). The non-linear channel encoder may be configured to encode and modulate the scrambled message sequence to generate a codeword 225 (e.g., c). For instance, the non-linear channel encoder (e.g., or one or more other modules) may perform encoding and modulation operations.

In some examples, the non-linear channel encoder may be an AI-based channel encoder. For instance, the non-linear channel encoder may be implemented based on one or more AI or ML models. Some examples of the models that may be utilized for the non-linear channel encoder may include one or more transformer models, one or more LLMs, or one or more generative artificial intelligence models, among other examples. Some examples of the techniques described herein may include or support AI-based channel coding or ML-based channel coding.

The UE 115-a may transmit a signal (e.g., signaling 205) based on (e.g., including) the codeword 225 generated from the non-linear channel encoder. For example, the transmitter at the UE 115-a may utilize one or more antennas to radiate the signaling 205, where the signaling 205 is based on (e.g., derived from) the codeword 225 generated from the encoder 220.

A receiving device (e.g., the network entity 105-a) may receive the signaling 205. For instance, the receiver may utilize one or more antennas to receive the signaling 205. The signaling 205 may be provided to a channel decoder. The channel decoder may perform decoding based on the signaling 205. For example, the channel decoder may demodulate or decode the signaling 205 (or another signal based on the signaling 205). In some examples, the channel decoder may be an AI-based channel decoder. For instance, the channel decoder may be implemented based on AI or ML models.

Thus, as described herein, message-level encoding (e.g., and decoding) of signaling 205 may support a same error probability for each message sequence 210 (e.g., for one or multiple message sequences).

In some examples, the UE 115-a may also support per-codeword power shaping (PS), which may be performed by the encoder 220. Per-codeword PS may support allocation of lower power to message sequences with high prior probabilities. A prior probability may refer to a prior probability distribution of an uncertain quantity, which may be referred to as a prior, and may be an assumed probability distribution before some elements or inputs are taken into account. The prior probability may refer to a probability distribution representing a relative proportion of one value or another. In some examples, the prior probability may refer to an assumed or estimated probability distribution of the message sequence.

For example, the UE 115-a may receive one or more downlink messages 230 from the network entity 105-a, and the UE 115-a may transmit uplink signaling (e.g., the signaling 205, among other examples) providing feedback for the downlink messages. For example, the UE 115-a may transmit a feedback codebook, such as a hybrid automatic repeat request (HARQ) ACK or NACK codebook including feedback bits indicating ACK and/or NACK information for the received downlink messages (e.g., PDSCH transmissions). In some examples, the UE 115-a may be more likely to transmit the ACK (e.g., bit 0) than the NACK (e.g., bit 1). For example, the network entity 105-a may schedule five messages on a physical downlink shared channel (PDSCH), and the UE 115-a may transmit a five bit message for HARQ ACK/NACK based on the decoding of the PDSCH transmissions. At a 10% BLER in PDSCH, the UE 115-a may transmit 90% ACK and 10% NACK or ACK (e.g., bit 0) with a 90% probability and NACK (e.g., bit 1) with a 10% probability. However, some codebooks may be designed for uniform probability of messages with equal likelihood of the bit 0 and bit 1, and power may be applied uniformly to the non-uniform message. Techniques for power control for non-uniform message transmissions may improve power savings. More power may be proportionally assigned to less likely symbols and less power to more likely symbols to save average transmit power and improve error performance.

In some examples, techniques for power control for non-uniform message transmissions may provide variable transmission power. For example, the power for each codeword may be scaled with respect to a Shannon coding length of the corresponding message. The UE 115-a may encode and modulate the sequence 210 (e.g., u) to obtain a codeword c(u) where Enc(u) represents a transmitted codeword. In some examples, Enc may represent a linear or a non-linear code encoder. The sequence 210 may include k bits, where u=[b₁, . . . bₖ]. In some cases, the modulation process may be binary-phase-shift keying (BPSK) per in-phase and quadrature components (I/Q) or may use one or more other modulation schemes. The UE 115-a may perform a power scaling procedure for the codeword c(u) based on a power scaling parameter. In some cases, the UE 115-a may receive the power scaling parameter from the network entity 105-a. In some examples, the power scaling parameter may be associated with a non-uniform probability of respective portions of the message sequence u. For example, the power scaling procedure may use a scaling parameter of c(u) with

$$log ( \frac{1}{p ( u )} )$$

where p(u) is a probability (e.g., which may be referred to as a prior probability) for the codeword c. For example, if the bits bᵢ of a message sequence u correspond to an independent and identically distributed (i.i.d.) Bernoulli (p), then p(u)=p^{#ACKS}(1-p)^{#NACKS}. The UE 115-a may scale the power according to the probability of a message sequence. For example, if a message sequence u has a probability of p(u), then the UE 115-a may scale the power of the corresponding codeword transmission c(u) with

$$log ( \frac{1}{p ( u )} ) .$$

After the power scaling, the UE 115-a may apply normalization. In some cases, the UE 115-a may apply a normalization parameter α. The normalization parameter α may have unit expected power across the codebook. In some cases, the scaling parameter of

$$log ( \frac{1}{p ( u )} )$$

may be connected to a Maxwell-Boltzmann distribution for probabilistic shaping log p(x)~|x|². In some examples, the UE 115-a may transmit the codeword based at least in part on the power scaling procedure and the normalization.

In some examples, techniques for power control for ACK/NACK transmission may scale power according to the probability of the message sequence. For example, if the message sequence u has probability p(u), then the power of the corresponding codeword transmission c(u) may be scaled with

$$log ( \frac{1}{p ( u )} ) .$$

After normalization with respect to unit expected power over the whole codebook, the message sequence u may be mapped to

$$log ( \frac{1}{p ( u )} ) * \frac{1}{{\sum }_{u ∈ U} p ( u ) log ( \frac{1}{p ( u )} )} * c ( u ) .$$

Consequently, all message sequences u with the same probability may correspond to (e.g., have) the same codeword power.

Thus, the UE 115-a may support non-linear (e.g., AI-based or ML-based) channel coding, which may result in per-codeword error probabilities of channel codes that are different from codeword to codeword. The UE 115-a may therefore support message-level scrambling to ensure each message sequence has a same error probability, which may include scrambling information bits (e.g., via the scrambler 215) prior to encoding (e.g., via the encoder 220). However, the UE 115-a may also support per-codeword PS to allocate low power to message sequences with high prior probabilities. Such allocation may be impacted by the message-level scrambling. For example, if a low probability message sequence is scrambled to a high probability message sequence, then the characteristics of the PS scheme may be violated (e.g., the UE 115-a may allocate low power to a message sequence with a high prior probability, but the sequence may be scrambled, resulting in a low prior probability, in which case the low power may be allocated to a message sequence with low prior probability, in direct opposition to the intended out come of the PS scheme).

Techniques described herein support non-linear channel encoding with message-level scrambling (e.g., supporting a same error probability across message sequences) in the case of per-codeword power shaping schemes (e.g., supporting more efficient allocation of power across message sequences). According to techniques described herein, the UE 115-a may perform message-level scrambling while ensuring that a message sequence u is scrambled to a message sequence u′ with the same prior probability. For instance, the UE 115-a may scramble one message sequence to another message sequence having the same prior probability (e.g., may scramble the contents of one message sequence by or in accordance with the contents of another message sequence, may multiply a first message sequence to a second message sequence, may multiply the first message sequence by a matrix, value, or in accordance with a function, may ensure that a scrambled message sequence has the same prior probability value as the unscrambled message sequence, or may perform any other procedure or operation such that a first message sequence is scrambled to a second message sequence having the same prior probability value). However, the UE 115-a may scramble a first message sequence to a second message sequence if the first and second message sequences have the same prior probability. Such techniques may reduce per-codeword BLER spread, without increasing the average BLER. For example, the PS procedure may reduce the BLER, and per-message scrambling using message sequences having the same prior probability may also support efficient power allocation (e.g., message-level scrambling with different prior probabilities may eliminate the benefits of PS schemes, and may therefore increase BLER).

In some examples, the UE 115-a may permute the information bits in accordance with a pseudorandom permutation function or rule. In such examples, the bits of the sequences to be scrambled may be independent and identically distributed bits. Because the bits are independent and identically distributed bits, the prior probability may be the same for all sequences of a set of sequences that have a same ACK count (e.g., a same quantity of ACKs for the signaling 205). The permuting of bits according to the pseudorandom permutation function or rule may not change the ACK count. Thus, by permuting the information bits with a pseudorandom permutation function, the UE 115-a may ensure that any message sequence of a set of message sequences (e.g., multiple message sequences or a single message sequence that correspond to the signaling 205) can be scrambled such that a first message sequence is scrambled to a second message sequence having a same prior probability as the first message sequence. Thus, the UE 115-a may ensure that all bits of a set of bits (e.g., all bits of a first message sequence and/or all bits of a set of message sequences) can be permuted in accordance with the pseudorandom permutation function or rule, which may result in a message-level scrambling that ensures that a message sequence is scrambled to a message sequence with the same prior probability.

In some examples, the UE 115-a may divide all message sequences into groups based on a prior probability value of the message sequences (e.g., such that each message sequence in a group or set of message sequences has the same prior probability value, and different groups or sets of message sequences correspond to different probability values). To perform message-level scrambling on a given message, the UE 115-a may identify to which group the message sequence belongs, and may select a message sequence from that group uniformly at random (e.g., and may scramble the message sequence by or in accordance with the selected message sequence). By ensuring that message sequences are selected from the same group (e.g., having the same prior probability value), the UE 115-a may perform the message-level scrambling such that a message sequence is scrambled to another message sequence with the same prior probability.

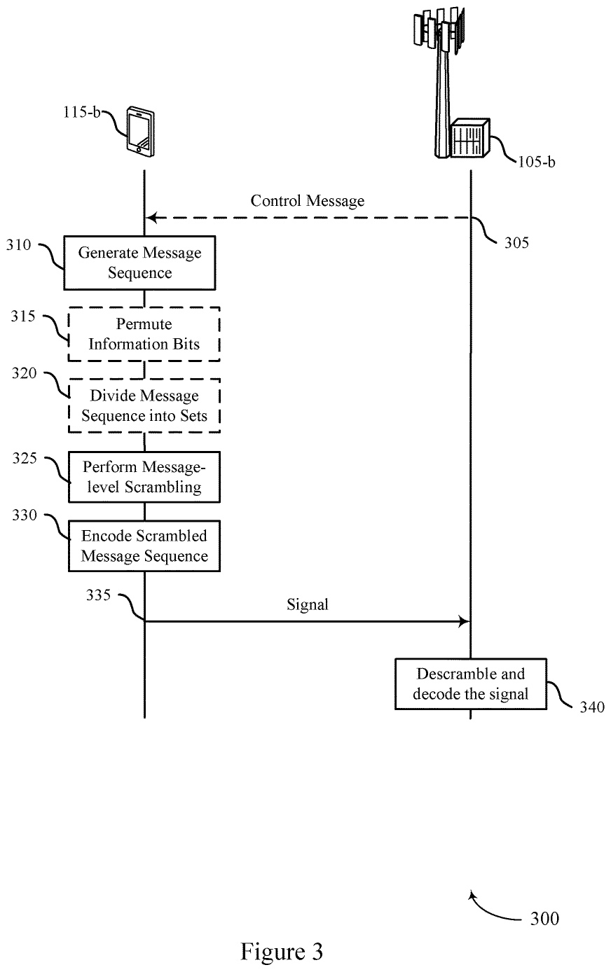

FIG. 3 shows an example of a process flow 300 that supports scrambling for non-linear channel encoding and power shaping. The process flow 300 may implement, or be implemented by, aspects of the wireless communications system 100, or the signaling diagram 200. For example, the process flow 300 may include a network entity 105-b and a UE 115-b, which may be examples of corresponding devices described with reference to FIGS. 1 and 2.

At 310, the UE 115-b may generate a message sequence. The message sequence may include, for example, feedback information (e.g., HARQ ACK or NACK signaling corresponding to received PDSCH signaling), uplink control signaling (e.g., PUCCH signaling), or uplink data signaling (e.g., PUSCH signaling). The message sequence may correspond to multiple message sequences, each message sequence corresponding to a respective prior probability value (e.g., p(u)). In some examples, the UE 115-b may perform PS techniques for the message sequence (e.g., in accordance with the PS techniques described herein with reference to FIG. 2).

At 325, the UE 115-b may perform message-level scrambling of the message sequence. The message-level scrambling may include scrambling a first message sequence of the multiple message sequences to a second message sequence of the multiple message sequences, and the second message sequence and the first message sequence may have the same prior probability value.

In some examples, at 315, the UE 115-b may permute information bits of the message sequence in accordance with a pseudorandom permutation function if each bit of the message sequence is sampled independently of all other bits of the message sequence, and each bit of the message sequence is sampled from a same distribution. In such examples, because the data bits are permuted in accordance with the pseudorandom permutation function (e.g., all of the bits are independent and identically distributed), the prior probability value of any given message sequence may be the same (e.g., such that the first message sequence scrambled to the second message sequence have the same prior probability value). That is, each respective prior probability value for each message sequence may be the same based on the pseudorandom permutation function, and scrambling the first message sequence to the second message sequence may be based on each respective prior probability value for a message sequence or multiple message sequences being the same.

In some examples, at 320, the UE 115-b may divide all message sequences into groups based on respective prior probabilities of each message sequence (e.g., such that all message sequences in each group have the same prior probability value). For a given message sequence, the UE 115-b may identify to which group a message sequence belongs, and may select a message sequence from that group uniformly at random. In some examples, the UE 115-b may divide the message sequences into one or more sets of message sequences (e.g., groups of message sequences), each message sequence of each set of message sequences corresponding to a same prior probability value. The UE 115-b may select the first message sequence from a first set of message sequences, each of which have the same prior probability value. The UE 115-b may select the second message sequence based on the second message sequence corresponding to the first set of message sequences (e.g., the same set of message sequences), and the second message sequence may correspond to the same prior probability value as the first message sequence because the first and second message sequences correspond to the same group. The UE 115-b may scramble the first message sequence to a second message sequence having the same prior probability value based on the group from which the first message sequence was selected. In some examples, scrambling the first message sequence to the second message sequence may include scrambling the first message sequence to a second message sequence within the same group. In some examples, the UE 115-b may select uniformly at random from the message sequences in the same group (e.g., another or a second message sequence) to scramble the first message sequence.

The UE 115-b may refrain from selecting a message sequence from a second set of message sequences based at least in part on the dividing of the message sequences into the one or more sets of message sequences. The second set of message sequences may correspond to an additional prior probability value that is different than the prior probability value of the first set of message sequences, and scrambling the first message sequence to the second message sequence is based at least in part on the refraining from selecting a message sequence from another set (e.g., group) having a different prior probability. Scrambling the first message sequence by another message sequence from a different set of message sequences that has a different prior probability value may be restricted (e.g., prohibited) based on the dividing (e.g., by one or more rules, which may be configured by the network entity 105-b or defined in one or more standards documents).

In some examples, the message-level scrambling may be based on a pseudorandom phase that is based on a seed. The control message at 305 may indicate the seed. In some examples, the seed may be based on a slot index, a frame index, a subframe index, a symbol index, a physical resource block index, a transmission index, a cell identifier, a device identifier, a radio network temporary identifier, or any combination thereof.

At 330, the UE 115-b may encode the scrambled message sequence. The UE 115-b may encode the scrambled message sequence based on a non-linear channel encoder, and may generate a codeword based on the scrambled message sequence.

At 335, the UE 115-b may transmit a signal including the codeword generated from the non-linear channel encoder. At 340, the network entity 105-b may descramble and decode the signal.

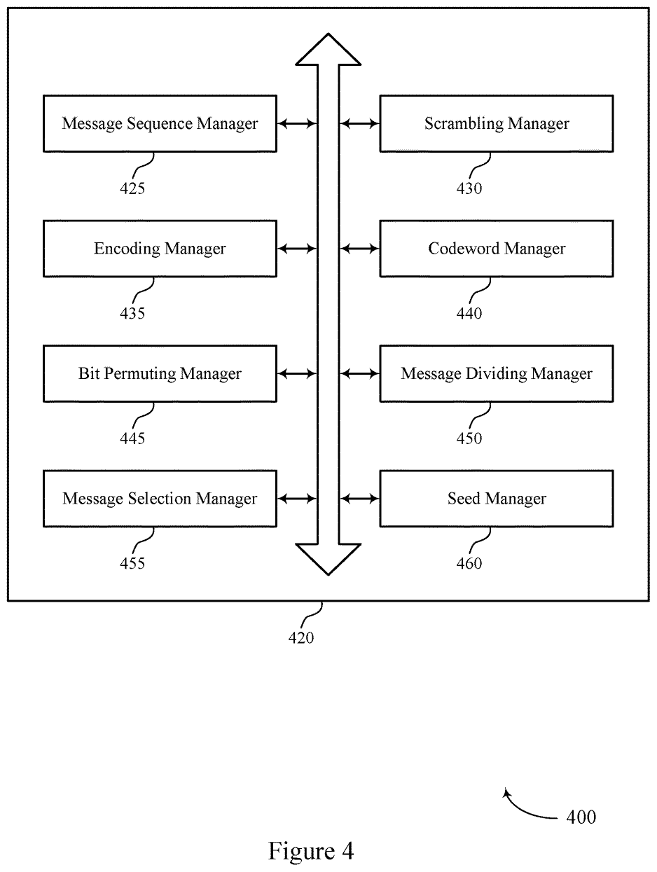

FIG. 4 shows an example 400 of a processing system 420 that supports scrambling for non-linear channel encoding and power shaping. A processing system 420 may be an example of a processing system 140 (such as of a UE 115) and may include a message sequence manager 425, a scrambling manager 430, an encoding manager 435, a codeword manager 440, a bit permuting manager 445, a message dividing manager 450, a message selection manager 455, a seed manager 460, or any combination thereof. A processing system 420, or various components thereof, may be an example of means for performing (such as a means for causing a UE 115 to perform) various techniques described herein.

The message sequence manager 425 may be configured to cause the UE 115 to generate a message sequence corresponding to (e.g., of) a set of multiple message sequences, each message sequence corresponding to a respective prior probability value. The scrambling manager 430 may be configured to cause the UE 115 to perform message-level scrambling of the message sequence, the message-level scrambling including scrambling a first message sequence of the set of multiple message sequences to a second message sequence of the set of multiple message sequences, where the second message sequence has a same prior probability value as the first message sequence. The encoding manager 435 may be configured to cause the UE 115 to encode the scrambled message sequence based on a non-linear channel encoder configured to encode and modulate the scrambled message sequence to generate a codeword. The codeword manager 440 may be configured to cause the UE 115 to transmit a signal including the codeword generated from the non-linear channel encoder.

In some examples, the bit permuting manager 445 may be configured to cause the UE 115 to permute information bits of the message sequence in accordance with a pseudorandom permutation function, based on each bit of the message sequence being sampled independently of all other bits of the message sequence and each bit of the message sequence being sampled from a same distribution.

In some examples, each respective prior probability value for each message sequence of the set of multiple message sequences is the same based on the pseudorandom permutation function, and scrambling the first message sequence of the set of multiple message sequences to the second message sequence is based on each respective prior probability value for each message sequence of the set of multiple message sequences being the same.

In some examples, the message dividing manager 450 may be configured to cause the UE 115 to divide the set of multiple message sequences into one or more sets of message sequences, each message sequence of each set of message sequences corresponding to a same prior probability value. In some examples, the message selection manager 455 may be configured to cause the UE 115 to select the first message sequence from the set of multiple message sequences for scrambling, the first message sequence corresponding to a first set of message sequences of the one or more sets of message sequences. In some examples, the message selection manager 455 may be configured to cause the UE 115 to select the second message sequence from the set of multiple message sequences based on the second message sequence corresponding to the first set of message sequences, where the second message sequence corresponds to the same prior probability value as the first message sequence based on the first message sequence and the second message sequence corresponding to the first set of message sequences in accordance with the dividing of the set of multiple message sequences into the one or more sets of message sequences.

In some examples, the message selection manager 455 may be configured to cause the UE 115 to refrain from selecting a message sequence from a second set of message sequences of the one or more sets of message sequences based on the dividing of the set of multiple message sequences into the one or more sets of message sequences, the second set of message sequences corresponding to an additional prior probability value that is different than the prior probability value of the first set of message sequences, where scrambling the first message sequence to the second message sequence is based on the refraining.

In some examples, scrambling the first message sequence by another message sequence from a second set of message sequences of the one or more sets of message sequences is restricted in accordance with the dividing.

In some examples, the seed manager 460 may be configured to cause the UE 115 to perform the message-level scrambling based on a pseudorandom phase that is based on a seed.

In some examples, the seed manager 460 may be configured to cause the UE 115 to receive control signaling indicating the seed.

In some examples, the seed is based on a slot index, a frame index, a subframe index, a symbol index, a physical resource block index, a transmission index, a cell identifier, a device identifier, a radio network temporary identifier, or any combination thereof.

A processing system 420 may include or be a component of one or more chips, systems-on-chips (SoCs), chipsets, packages, components, or devices that individually or collectively constitute or include a processing system. A processing system 420 may interface with other components of a processing system 420. For example, operations described with reference to a processing system 420, or various components thereof, may be performed by or with other such components, including a receiver, a transmitter, a transceiver, a modem, a user interface, a modulator/demodulator, an encoder/decoder, or any combination thereof (such as of the processing system 420, coupled with the processing system 420, of a processing system 420).

By including or configuring a processing system 420 as described herein, the processing system 420 may support techniques for message-level scrambling resulting in reduced per-codeword BLER spread, without increasing the average BLER, improved reliability of wireless signaling, increased throughput, decreased system latency, improved reliability of wireless communications, and improved user experience.

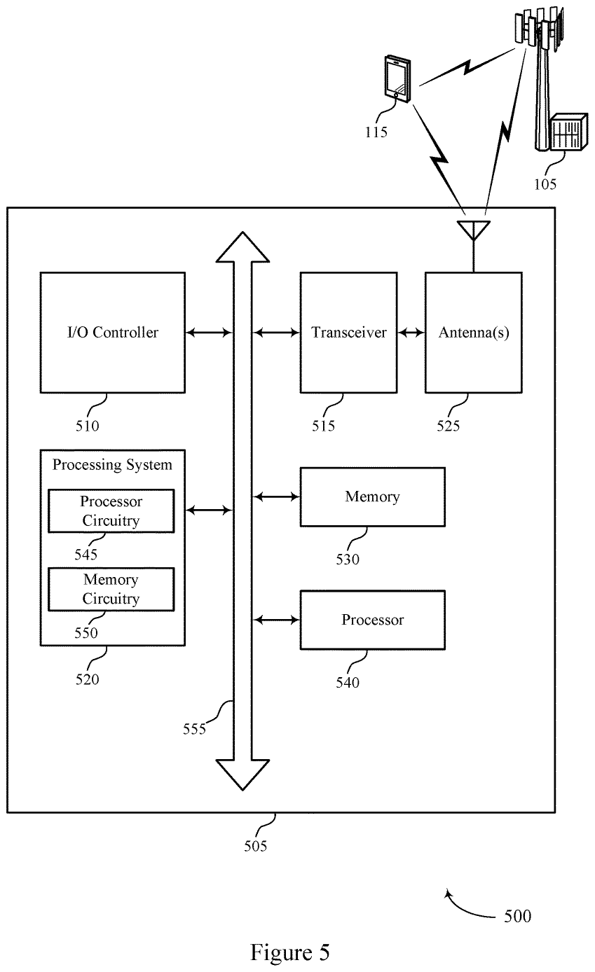

FIG. 5 shows an example of a system 500 including a device 505 that supports scrambling for non-linear channel encoding and power shaping. The device 505 may be an example of or include components of UE 115. The device 505 may communicate (such as wirelessly) with one or more other devices (such as network entities 105, UEs 115). The device 505 may include components for transmitting and receiving communication, which may include a processing system 520, an input/output (I/O) controller, such as an I/O controller 510, a transceiver 515, antenna(s) 525, a memory 530, and a processor 540. Components of the device 505 may be coupled (such as operatively, communicatively, functionally, electronically, electrically, in electronic communication) via a bus 555.

The transceiver 515 may support bi-directional communication via antenna(s) 525, and may support transmission operations, reception operations, or both, as described herein. The transceiver 515 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 505). The transceiver 515 may modulate symbols and provide the modulated symbols to antenna(s) 525 for transmission, and demodulate symbols from signals received using antenna(s) 525.

The processor 540 may be a general-purpose processing component that supports various operations (such as applications) of the device 505. The memory 530 may be a general-purpose storage component that stores code executable by the processor 540. Such code may include instructions that, when executed by the processor 540, cause the device 505 to perform various functions (such as to support an application of the device 505). The I/O controller 510 may manage inputs and outputs for the device 505, may manage peripherals not integrated into the device 505, or may represent a physical connection (such as a port) to an external peripheral. The processor 540 may interact with a modem, a keyboard, a mouse, a touchscreen, or other device (such as via I/O controller 510). In some implementations, a user may interact with the device 505 via the I/O controller 510 or via hardware components controlled by the I/O controller 510.

The processing system 520 may be an example of a processing system 140 or a processing system 420. For example, the processing system 520 may include processor circuitry 545 and memory circuitry 550 that stores code, and may be configured to cause the device 505 to perform operations that support scrambling for non-linear channel encoding and power shaping. Although the processing system 520 is illustrated as a separate component, which may involve a separate chip, chipset, or other module, in some implementations, one or more functions described with reference to the processing system 520 may be supported by or performed by a transceiver 515, antenna(s) 525, a processor 540, memory 530, or any combination thereof, such that a processing system 520 may include one or more of a transceiver 515, antenna(s) 525, a processor 540, memory 530, or any combination thereof.

By including or configuring the processing system 520 for operation in the device 505 as described herein, the device 505 may support techniques for message-level scrambling resulting in reduced per-codeword BLER spread without increasing the average BLER, improved reliability of wireless signaling, increased throughput, decreased system latency, improved reliability of wireless communications, and improved user experience.

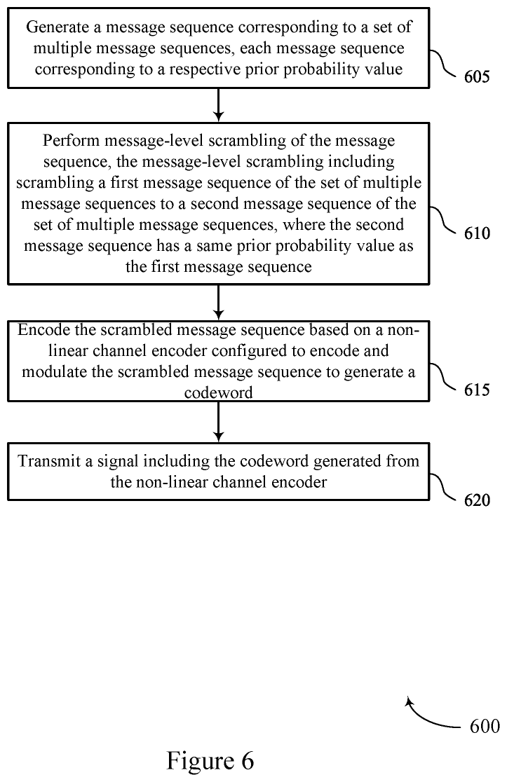

FIG. 6 shows an example of a method 600 that supports scrambling for non-linear channel encoding and power shaping. Operations of the method 600 may be performed by a UE or its components (such as using a processing system configured to cause the UE 115 to perform one or more of the operations) as described herein.

At 605, the method may include generating a message sequence corresponding to a set of multiple message sequences, each message sequence corresponding to a respective prior probability value. In some examples, aspects of the operations of 605 may be performed by a message sequence manager 425.

At 610, the method may include performing message-level scrambling of the message sequence, the message-level scrambling including scrambling a first message sequence of the set of multiple message sequences to a second message sequence of the set of multiple message sequences, where the second message sequence has a same prior probability value as the first message sequence. In some examples, aspects of the operations of 610 may be performed by a scrambling manager 430.

At 615, the method may include encoding the scrambled message sequence based on a non-linear channel encoder configured to encode and modulate the scrambled message sequence to generate a codeword. In some examples, aspects of the operations of 615 may be performed by an encoding manager 435.

At 620, the method may include transmitting a signal including the codeword generated from the non-linear channel encoder. In some examples, aspects of the operations of 620 may be performed by a codeword manager 440.

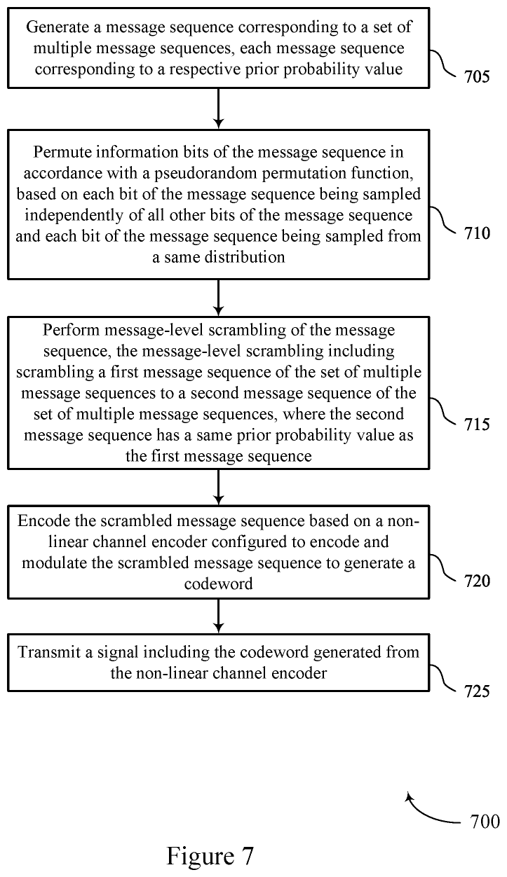

FIG. 7 shows an example of a method 700 that supports scrambling for non-linear channel encoding and power shaping. Operations of the method 700 may be performed by a UE or its components (such as using a processing system configured to cause the UE 115 to perform one or more of the operations) as described herein.

At 705, the method may include generating a message sequence corresponding to a set of multiple message sequences, each message sequence corresponding to a respective prior probability value. In some examples, aspects of the operations of 705 may be performed by a message sequence manager 425.

At 710, the method may include permuting information bits of the message sequence in accordance with a pseudorandom permutation function, based on each bit of the message sequence being sampled independently of all other bits of the message sequence and each bit of the message sequence being sampled from a same distribution. In some examples, aspects of the operations of 710 may be performed by a bit permuting manager 445.

At 715, the method may include performing message-level scrambling of the message sequence, the message-level scrambling including scrambling a first message sequence of the set of multiple message sequences to a second message sequence of the set of multiple message sequences, where the second message sequence has a same prior probability value as the first message sequence. In some examples, aspects of the operations of 715 may be performed by a scrambling manager 430.

At 720, the method may include encoding the scrambled message sequence based on a non-linear channel encoder configured to encode and modulate the scrambled message sequence to generate a codeword. In some examples, aspects of the operations of 720 may be performed by an encoding manager 435.

At 725, the method may include transmitting a signal including the codeword generated from the non-linear channel encoder. In some examples, aspects of the operations of 725 may be performed by a codeword manager 440.

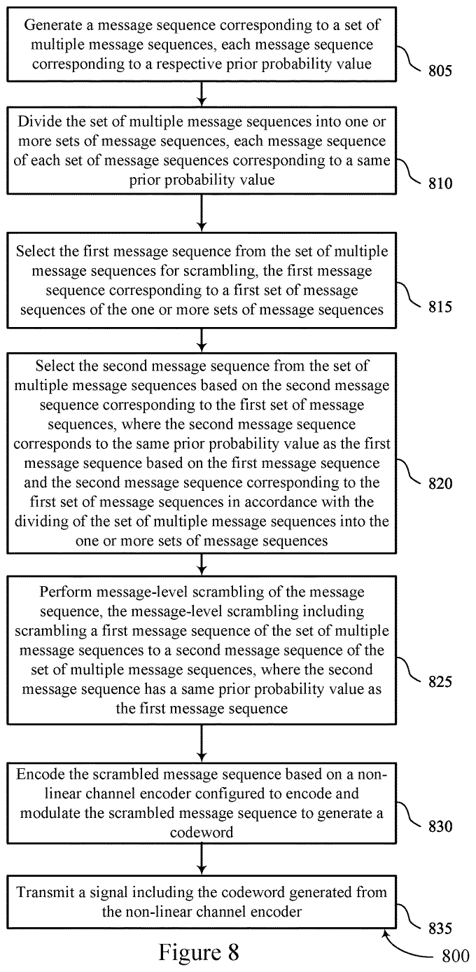

FIG. 8 shows an example of a method 800 that supports scrambling for non-linear channel encoding and power shaping. Operations of the method 800 may be performed by a UE or its components (such as using a processing system configured to cause the UE 115 to perform one or more of the operations) as described herein.

At 805, the method may include generating a message sequence corresponding to a set of multiple message sequences, each message sequence corresponding to a respective prior probability value. In some examples, aspects of the operations of 805 may be performed by a message sequence manager 425.

At 810, the method may include dividing the set of multiple message sequences into one or more sets of message sequences, each message sequence of each set of message sequences corresponding to a same prior probability value. In some examples, aspects of the operations of 810 may be performed by a message dividing manager 450.

At 815, the method may include selecting the first message sequence from the set of multiple message sequences for scrambling, the first message sequence corresponding to a first set of message sequences of the one or more sets of message sequences. In some examples, aspects of the operations of 815 may be performed by a message selection manager 455.

At 820, the method may include selecting the second message sequence from the set of multiple message sequences based on the second message sequence corresponding to the first set of message sequences, where the second message sequence corresponds to the same prior probability value as the first message sequence based on the first message sequence and the second message sequence corresponding to the first set of message sequences in accordance with the dividing of the set of multiple message sequences into the one or more sets of message sequences. In some examples, aspects of the operations of 820 may be performed by a message selection manager 455.

At 825, the method may include performing message-level scrambling of the message sequence, the message-level scrambling including scrambling a first message sequence of the set of multiple message sequences to a second message sequence of the set of multiple message sequences, where the second message sequence has a same prior probability value as the first message sequence. In some examples, aspects of the operations of 825 may be performed by a scrambling manager 430.

At 830, the method may include encoding the scrambled message sequence based on a non-linear channel encoder configured to encode and modulate the scrambled message sequence to generate a codeword. In some examples, aspects of the operations of 830 may be performed by an encoding manager 435.

At 835, the method may include transmitting a signal including the codeword generated from the non-linear channel encoder. In some examples, aspects of the operations of 835 may be performed by a codeword manager 440.

Implementation examples are described in the following numbered clauses:

Aspect 1: A method for wireless communications at a UE, comprising: generating a message sequence corresponding to a plurality of message sequences, each message sequence corresponding to a respective prior probability value; performing message-level scrambling of the message sequence, the message-level scrambling comprising scrambling a first message sequence of the plurality of message sequences to a second message sequence of the plurality of message sequences, wherein the second message sequence has a same prior probability value as the first message sequence; encoding the scrambled message sequence based at least in part on a non-linear channel encoder configured to encode and modulate the scrambled message sequence to generate a codeword; and transmitting a signal comprising the codeword generated from the non-linear channel encoder.

Aspect 2: The method of aspect 1, further comprising: permuting information bits of the message sequence in accordance with a pseudorandom permutation function, based at least in part on each bit of the message sequence being sampled independently of all other bits of the message sequence and each bit of the message sequence being sampled from a same distribution.

Aspect 3: The method of aspect 2, wherein each respective prior probability value for each message sequence of the plurality of message sequences is the same based at least in part on the pseudorandom permutation function, and scrambling the first message sequence of the plurality of message sequences to the second message sequence is based at least in part on each respective prior probability value for each message sequence of the plurality of message sequences being the same.

Aspect 4: The method of any of aspects 1 through 3, further comprising: dividing the plurality of message sequences into one or more sets of message sequences, each message sequence of each set of message sequences corresponding to a same prior probability value; selecting the first message sequence from the plurality of message sequences for scrambling, the first message sequence corresponding to a first set of message sequences of the one or more sets of message sequences; and selecting the second message sequence from the plurality of message sequences based at least in part on the second message sequence corresponding to the first set of message sequences, wherein the second message sequence corresponds to the same prior probability value as the first message sequence based at least in part on the first message sequence and the second message sequence corresponding to the first set of message sequences in accordance with the dividing of the plurality of message sequences into the one or more sets of message sequences.

Aspect 5: The method of aspect 4, further comprising: refraining from selecting a message sequence from a second set of message sequences of the one or more sets of message sequences based at least in part on the dividing of the plurality of message sequences into the one or more sets of message sequences, the second set of message sequences corresponding to an additional prior probability value that is different than the prior probability value of the first set of message sequences, wherein scrambling the first message sequence to the second message sequence is based at least in part on the refraining.

Aspect 6: The method of any of aspects 4 through 5, wherein scrambling the first message sequence by another message sequence from a second set of message sequences of the one or more sets of message sequences is restricted in accordance with the dividing.

Aspect 7: The method of any of aspects 1 through 6, further comprising: performing the message-level scrambling based at least in part on a pseudorandom phase that is based at least in part on a seed.

Aspect 8: The method of aspect 7, further comprising: receiving control signaling indicating the seed.

Aspect 9: The method of any of aspects 7 through 8, wherein the seed is based at least in part on a slot index, a frame index, a subframe index, a symbol index, a physical resource block index, a transmission index, a cell identifier, a device identifier, a radio network temporary identifier, or any combination thereof.

Aspect 10: A UE for wireless communications, comprising a processing system that includes processor circuitry and memory circuitry that stores code, the processing system configured to cause the UE to perform a method of any of aspects 1 through 9.

Aspect 11: A UE for wireless communications, comprising at least one means for performing a method of any of aspects 1 through 9.

Aspect 12: A non-transitory computer-readable medium storing code for wireless communications, the code comprising instructions executable by one or more processors to perform a method of any of aspects 1 through 9.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
generate a message sequence corresponding to a plurality of message sequences, each message sequence corresponding to a respective prior probability value;
perform message-level scrambling of the message sequence, the message-level scrambling comprising scrambling a first message sequence of the plurality of message sequences to a second message sequence of the plurality of message sequences, wherein the second message sequence has a same prior probability value as the first message sequence;
encode the scrambled message sequence based at least in part on a non-linear channel encoder configured to encode and modulate the scrambled message sequence to generate a codeword; and
transmit a signal comprising the codeword generated from the non-linear channel encoder.

2. The UE of claim 1, wherein the one or more processors are individually or collectively further operable to execute the code to cause the UE to:
permute information bits of the message sequence in accordance with a pseudorandom permutation function, based at least in part on each bit of the message sequence being sampled independently of all other bits of the message sequence and each bit of the message sequence being sampled from a same distribution.

3. The UE of claim 2, wherein each respective prior probability value for each message sequence of the plurality of message sequences is the same based at least in part on the pseudorandom permutation function, and the first message sequence of the plurality of message sequences is scrambled to the second message sequence based at least in part on each respective prior probability value for each message sequence of the plurality of message sequences being the same.

4. The UE of claim 1, wherein the one or more processors are individually or collectively further operable to execute the code to cause the UE to:
divide the plurality of message sequences into one or more sets of message sequences, each message sequence of each set of message sequences corresponding to a same prior probability value;
select the first message sequence from the plurality of message sequences for scrambling, the first message sequence corresponding to a first set of message sequences of the one or more sets of message sequences; and
select the second message sequence from the plurality of message sequences based at least in part on the second message sequence corresponding to the first set of message sequences, wherein the second message sequence corresponds to the same prior probability value as the first message sequence based at least in part on the first message sequence and the second message sequence corresponding to the first set of message sequences in accordance with the division of the plurality of message sequences into the one or more sets of message sequences.

5. The UE of claim 4, wherein the one or more processors are individually or collectively further operable to execute the code to cause the UE to:
refrain from selection of a message sequence from a second set of message sequences of the one or more sets of message sequences based at least in part on the division of the plurality of message sequences into the one or more sets of message sequences, the second set of message sequences corresponding to an additional prior probability value that is different than the prior probability value of the first set of message sequences, wherein the first message sequence is scrambled to the second message sequence based at least in part on having refrained from selection of the message sequence from the second set of message sequences.

6. The UE of claim 4, wherein scrambling the first message sequence by another message sequence from a second set of message sequences of the one or more sets of message sequences is restricted in accordance with the division.

7. The UE of claim 1, wherein the one or more processors are individually or collectively further operable to execute the code to cause the UE to:
perform the message-level scrambling based at least in part on a pseudorandom phase that is based at least in part on a seed.

8. The UE of claim 7, wherein the one or more processors are individually or collectively further operable to execute the code to cause the UE to:
receive control signaling that indicates the seed.

9. The UE of claim 7, wherein the seed is based at least in part on a slot index, a frame index, a subframe index, a symbol index, a physical resource block index, a transmission index, a cell identifier, a device identifier, a radio network temporary identifier, or any combination thereof.

10. A method for wireless communications at a user equipment (UE), comprising:
generating a message sequence corresponding to a plurality of message sequences, each message sequence corresponding to a respective prior probability value;
performing message-level scrambling of the message sequence, the message-level scrambling comprising scrambling a first message sequence of the plurality of message sequences to a second message sequence of the plurality of message sequences, wherein the second message sequence has a same prior probability value as the first message sequence;
encoding the scrambled message sequence based at least in part on a non-linear channel encoder configured to encode and modulate the scrambled message sequence to generate a codeword; and
transmitting a signal comprising the codeword generated from the non-linear channel encoder.

11. The method of claim 10, further comprising:
permuting information bits of the message sequence in accordance with a pseudorandom permutation function, based at least in part on each bit of the message sequence being sampled independently of all other bits of the message sequence and each bit of the message sequence being sampled from a same distribution.

12. The method of claim 11, wherein each respective prior probability value for each message sequence of the plurality of message sequences is the same based at least in part on the pseudorandom permutation function, and scrambling the first message sequence of the plurality of message sequences to the second message sequence is based at least in part on each respective prior probability value for each message sequence of the plurality of message sequences being the same.

13. The method of claim 10, further comprising:
dividing the plurality of message sequences into one or more sets of message sequences, each message sequence of each set of message sequences corresponding to the same prior probability value;
selecting the first message sequence from the plurality of message sequences for scrambling, the first message sequence corresponding to a first set of message sequences of the one or more sets of message sequences; and
selecting the second message sequence from the plurality of message sequences based at least in part on the second message sequence corresponding to the first set of message sequences, wherein the second message sequence corresponds to the same prior probability value as the first message sequence based at least in part on the first message sequence and the second message sequence corresponding to the first set of message sequences in accordance with the dividing of the plurality of message sequences into the one or more sets of message sequences.

14. The method of claim 13, further comprising:
refraining from selecting a message sequence from a second set of message sequences of the one or more sets of message sequences based at least in part on the dividing of the plurality of message sequences into the one or more sets of message sequences, the second set of message sequences corresponding to an additional prior probability value that is different than the prior probability value of the first set of message sequences, wherein scrambling the first message sequence to the second message sequence is based at least in part on the refraining.

15. The method of claim 13, wherein scrambling the first message sequence by another message sequence from a second set of message sequences of the one or more sets of message sequences is restricted in accordance with the dividing.

16. The method of claim 10, further comprising:
performing the message-level scrambling based at least in part on a pseudorandom phase that is based at least in part on a seed.

17. The method of claim 16, further comprising:
receiving control signaling indicating the seed.

18. The method of claim 16, wherein the seed is based at least in part on a slot index, a frame index, a subframe index, a symbol index, a physical resource block index, a transmission index, a cell identifier, a device identifier, a radio network temporary identifier, or any combination thereof.

19. A non-transitory computer-readable medium storing code for wireless communications, the code comprising instructions executable by one or more processors to:
generate a message sequence corresponding to a plurality of message sequences, each message sequence corresponding to a respective prior probability value;
perform message-level scrambling of the message sequence, the message-level scrambling comprising scrambling a first message sequence of the plurality of message sequences to a second message sequence of the plurality of message sequences, wherein the second message sequence has a same prior probability value as the first message sequence;
encode the scrambled message sequence based at least in part on a non-linear channel encoder configured to encode and modulate the scrambled message sequence to generate a codeword; and
transmit a signal comprising the codeword generated from the non-linear channel encoder.

20. The non-transitory computer-readable medium of claim 19, wherein the instructions are further executable by the one or more processors to:
permute information bits of the message sequence in accordance with a pseudorandom permutation function, based at least in part on each bit of the message sequence being sampled independently of all other bits of the message sequence and each bit of the message sequence being sampled from a same distribution.
